(19) United States
(12) Patent Application Publication
(10) Pub. No.: US 2014/0130982 A1
(43) Pub. Date: May 15, 2014

(54) Thin film processing apparatus

(71) Applicants: Chiung-Chieh Su, Longtan Township (TW); Sung-Cheng Hu, Longtan Township (TW); Chin-Horng Yau, Longtan Township (TW); Lin-Sheng Jin, Longtan Township (TW); Ming-June Lin, Longtan Township (TW); Meng-Chiuan Yu, Longtan Township (TW)

(72) Inventors: Chiung-Chieh Su, Longtan Township (TW); Sung-Cheng Hu, Longtan Township (TW); Chin-Horng Yau, Longtan Township (TW); Lin-Sheng Jin, Longtan Township (TW); Ming-June Lin, Longtan Township (TW); Meng-Chiuan Yu, Longtan Township (TW)

(73) Assignee: CHUNG SHAN INSTITUTE OF SCIENCE AND TECHNOLOGY, ARMAMENTS BUREAU, M. N. D

(21) Appl. No.: 13/674,955

(22) Filed: Nov. 13, 2012

(51) Int. Cl. B32B 37/06

(52) U.S. Cl. CPC B32B 37/06
USPC 156/378; 156/499; 156/380.9

(57) ABSTRACT

A thin film processing apparatus assembles a substrate and an auxiliary plate tightly and the substrate is coated with a thin film whereon the auxiliary plate is situated. Since the substrate or the auxiliary plate is transparent for thermal radiation, the thin film heated by thermal radiation symmetrically in thickness direction will be available. Consequentially debonding, warping and cracking of thin film are thus prevented and outgassing from thin film is eliminated as well.

### BACKGROUND OF THE INVENTION

1. Field of the Invention

The present invention is related to a thin film processing apparatus-which assembles a substrate and an auxiliary plate tightly. The substrate is coated with thin film whereon the auxiliary plate is situated. Since the substrate or the auxiliary plate is also transparent for thermal radiation, the thin film may be heated thicknesswise symmetrically by thermal radiation.

2. Description of Related Art

A thin film in the thickness of μm (such as polysilicon, CIGS) is usually deposited on a substrate of certain thickness (e.g. 3 mm glass) for most conventional photovoltaic elements which needs a certain thermal processing procedure to obtain photoelectric function. For example, the temperature of thermal processing for polysilicon is about 900° C., and that for CIGS is approximately 550° C. In addition, most conventional thermal processing apparatuses are of hot wall, they require tens minutes or even hours to get the desired effect. Under such circumstances, a low-cost mass production becomes impossible.

In order to meet the requirements of high productivity, the processing time must be short. The thin film processing structure as shown in FIG. 6 was thus developed. It includes a heating unit 4, a substrate 5 and a thin film 6 which is coated on the substrate 5 and to be processed. Whereby the thermal processing of thin film 6 can be finished in less than 60 seconds. However, under such a rapid thermal processing, high temperature gradient and thermal stress induced will exist between the thin film 6 and the substrate 5 and cause the thin film 6 warped, cracked and peeled. Besides, some specific elements (such as selenium) may be evaporated and dissipated during thermal processing (e.g. CIGS solar cell) and this is going to result in incomplete reaction and, of course, low yield of production.

Another conventional “heat treatment method” is to lay a second substrate on the first one with thin films contacting each other. Then a weight is situated on the second substrate and carefully adjusted to prevent the substrate deformed. However if the weight is not heavy or even enough, the coated thin film is likely to warp, crack and be peeled from the substrate.

### SUMMARY OF THE INVENTION

The objective of the present invention is related to a thin film processing apparatus which assembles a substrate and an auxiliary plate tightly. The substrate is coated with thin film whereon the auxiliary plate is situated. Since the substrate or the auxiliary plate is transparent for thermal radition, the thin film heated by thermal radiation symmetrically in thickness direction will be available. Consequentially debonding, warping and cracking of thin film are thus prevented and outgassing from thin film is eliminated as well.

In order to achieve the above mentioned objective, the thin film processing apparatus of the present invention includes a heating module, a loading module, and a thin film to be processed.

In one embodiment of the present invention, the heating module consists of a heating unit, a temperature control unit and a pyrometry unit.

In one embodiment of the present invention, the heating unit has a plurality of radiant tungsten halogen lamps.

In one embodiment of the present invention, the substrate and the auxiliary plate are made of glass and each has the same thickness and thermal radiative properties.

In one embodiment of the present invention, the thin film to be processed is not transparent for thermal radiation.

In one embodiment of the present invention, the pyrometer measures thin film temperature via the substrate or the auxiliary plate.

In one embodiment of the present invention, the substrate or the auxiliary plate is transparent for thermal radiation.

In one embodiment of the present invention, the heating unit and the pyrometer are located on either side or the same side of the thin film.

In one embodiment of the present invention, the auxiliary plate has a concave region at the substrate joining side, so that the thin film is securely positioned and sealed.

In one embodiment of the present invention, the auxiliary plate has a concave region at the substrate joining side and the concave region connected with a filling unit.

In one embodiment of the present invention, the filling unit comprises a vapor supplier and a tube connecting concave region and vapor suppier.

In one embodiment of the present invention, the thin film to be processed is of solar cell.

### BRIEF DESCRIPTION OF THE DRAWINGS

The invention, as well as its many advantages, may be further understood by the following detailed description and drawings in which:

FIG. 1 is a schematic cross-sectional view of a first embodiment of the present invention.

FIG. 2 is a partially enlarged schematic view showing the portion A of FIG. 1 of the present invention.

FIG. 3 is a schematic cross-sectional view of a second embodiment of the present invention.

FIG. 4 is a schematic cross-sectional view of a third embodiment of the present invention.

FIG. 5 is a partially enlarged schematic view showing the portion B of FIG. 4 of the present invention.

FIG. 6 is the schematic view showing the conventional thermal processing of thin film.

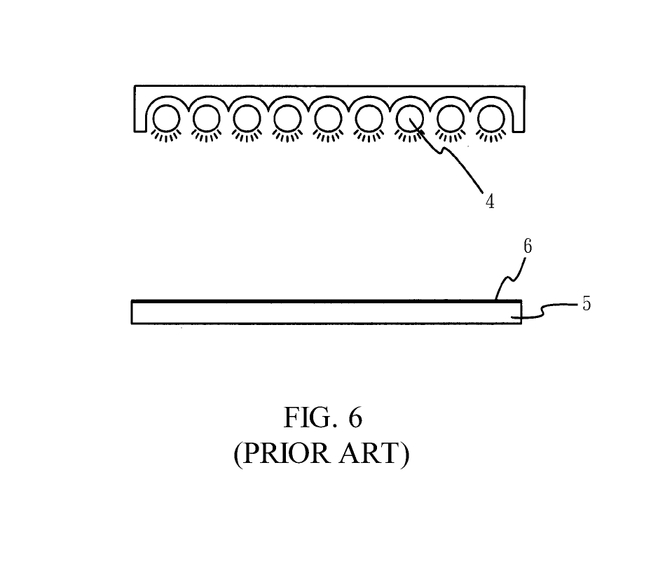

### DETAILED DESCRIPTION OF THE INVENTION

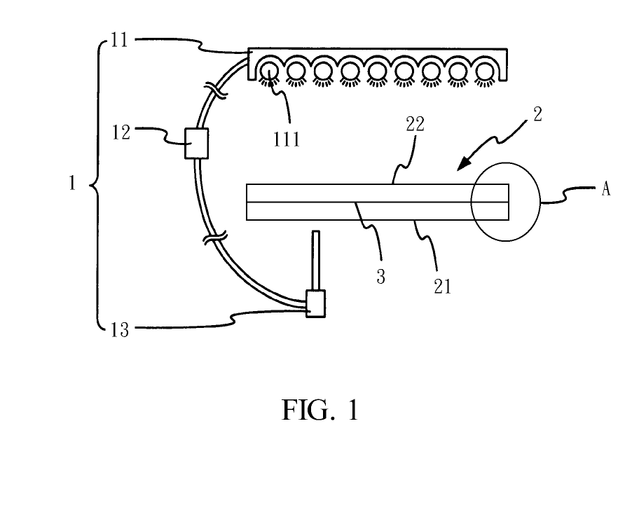

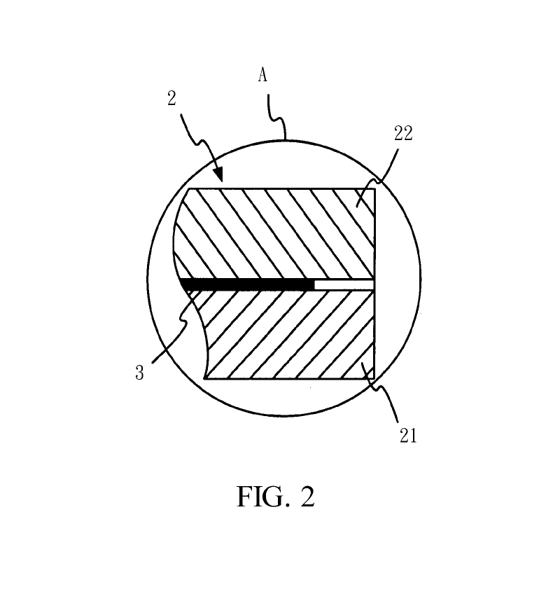

FIG. 1 and FIG. 2 are respectively a schematic cross-sectional view of a first embodiment of the present invention and a partially enlarged schematic view showing the portion A of FIG. 1 of the present invention. As shown in FIG. 1, a thin film processing apparatus of the present invention includes at least a heating module 1, a loading module 2, and a thin film 3 to be processed.

The heating module 1 includes a heating unit 11, a temperature control unit 12 and a pyrometry unit 13. The temperature control unit 12 is connected with the pyrometry unit 13 and the heating unit 11 which including a multiplicity of radiant tungsten halogen lamp 111.

The loading module 2 includes a substrate 21 and an auxiliary plate 22 and both are jointed tightly. The substrate 21 and the auxiliary plate 22 are made of radiatively transparent materials, e.g. glass, having equivalently the same thermal properties such as thickness, density, conductivity, specific heat, etc.

The substrate 21 is coated with the thin film 3 whereon the auxiliary plate 22 is situated. The thin film 3 basically is not penetrated by thermal radiation and it may be of solar cell. Thereby a completely new kind of thin film processing apparatus is constructed.

Practically the thin film 3 is located between the substrate 21 and the auxiliary plate 22. The gravity of auxiliary plate 22 (or exerting additional force) will make the thin film 3 tightly contact the auxiliary plate 22 so that the thin film 3 is securely positioned and sealed. A working platform with rollers (not shown in the presented figures) is used to control the movement of loading module 2 and so the apparatus will have a maximum processing area without shielding the thermal radiation from heating unit 11. The tungsten halogen lamps 111 of heating unit 11 will emit thermal radiation penetrating the auxiliary plate 22 and heating the thin film 3. At the same time, the pyrometry unit 13 measures the temperature of the thin film 3 via the substrate 21 and the data of measured temperature are transferred to the temperature control unit 12 for adjusting the input power of each tungsten halogen lamp 111 in accordance with the temperature requirement of thin film. In addition, tungsten halogen lamps 111 can be controlled on zone-by-zone basis so that the thin film 3 will be uniformly and rapidly heated. Besides, the thermal radiation of tungsten halogen lamp unit 11 can penetrate the auxiliary plate 22 to heat the thin film 3 as well as the material, size and thermal properties on both sides of the thin film are equivalently the same. Then the temperature distribution of loading module 2 will be thicknesswise symmetric and so is the thermal stress distribution. Consequentially debonding, warping and cracking of the thin film 3 are thus prevented and outgassing from thin film is eliminated. The present invention will not only obtain a better repeatability for directly controlling the temperature of thin film 3, but also conserve more energy because of the tungsten halogen tube 111 directly heating the thin film 3.

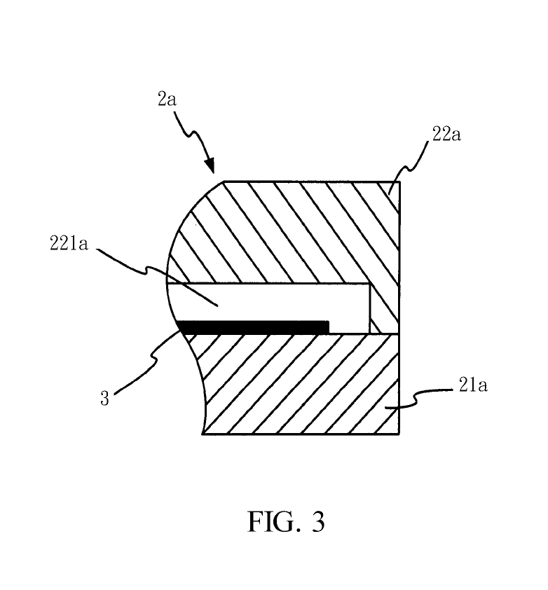

FIG. 3 is a schematic cross-sectional view of a second embodiment of the present invention. As shown in the figure, besides the arrangement mentioned in the first embodiment of the present invention, the second embodiment of the present invention is provided. The differences therebetween are that the auxiliary plate 22a of the loading module 2a has a concave region 221a on the substrate joining side, so that the thin film 3 is securely positioned and sealed with suitable clearance between the thin film 3 and the concave region 221a. Because the specific element (such as selenium) in the thin film 3 can be evaporated and dissipated during thermal processing, the second embodiment of the present invention is to form a closed cavity between the thin film 3 and the concave region 221a. It will have the dissipated specific element return to the thin film 3 so as to improve the incomplete reaction in the thin film 3.

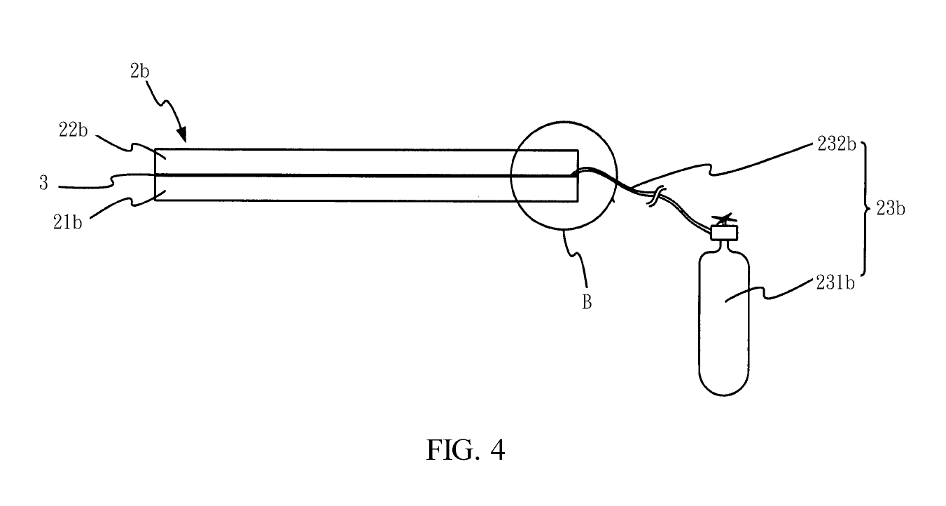

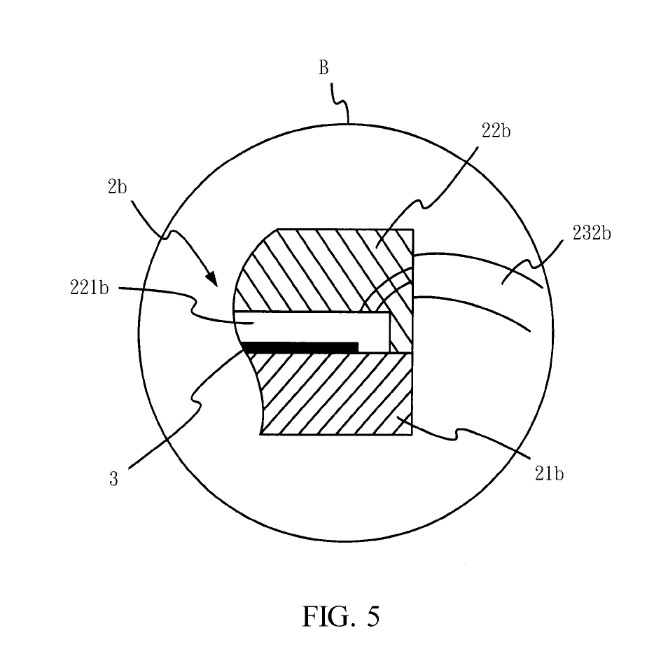

FIG. 4 and FIG. 5 are respectively a schematic cross-sectional view of a third embodiment of the present invention and a partially enlarged schematic view showing the portion B of FIG. 4 of the present invention. As shown in the figures, besides the arrangements mentioned in the first and second embodiments of the present invention, the third embodiment of the present invention is provided. The differences thereamong are as the following. The auxiliary plate 22b of the loading module 2b has a concave region 221b on the substrate joining side, so that the thin film 3 is securely positioned and sealed with suitable clearance between the thin film 3 and the concave region 221b. The concave region 221b is then connected with a filling unit 23b which comprises a vapor supplier 231b and a tube 232b connecting the concave region 221b and the vapor supplier 231b. Because the specific element (such as selenium) in the thin film 3 may be evaporated and dissipated during thermal processing. The third embodiment of the present invention is first to form a closed cavity between the thin film 3 and the concave region 221b. Then the vapor supplier 231b will deliver the dissipated element to the thin film 3 through the tube 232b so as to improve the incomplete reaction in the thin film 3.

In summary, the thin film processing apparatus of the present invention tightly joins a substrate and an auxiliary plate. The substrate is coated with thin film whereon the auxiliary plate is situated so that the thin film is securely positioned and sealed. Since the substrate or the auxiliary plate is transparent for thermal irradiating, the thin film will be heated thicknesswise symmetrically. In addition, the tungsten halogen lamps can be controlled on zone-by-zone basis, the thin film will be uniformly and rapidly heated. Consequentially debonding, warping and cracking of thin film are thus prevented and outgassing from thin film is eliminated as well. The apparatus will not only obtain a better repeatability for directly controlling the temperature of thin film, but also conserve more energy because of tungsten halogen tube directly heating thin film. Thereby the present invention is progressive, practical, fulfilling consumers demand, meeting the elements of patent and thus being filed for the patent application in accordance with the law.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

1. A thin film processing apparatus, comprising:
a heating module having a heating unit, a pyrometry unit, and a temperature control unit;
a loading module having a substrate and an auxiliary plate, wherein the loading module is surrounded with the heating module and defined between the heating unit and the pyrometry unit; and
a thin film coated on the substrate and directly being contacted with the substrate and the auxiliary plates.

2. The thin film processing apparatus as claimed in claim 1, wherein the substrate and the auxiliary plate are jointed tightly so that the thin film is securely positioned and sealed.

3. The thin film processing apparatus as claimed in claim 1, wherein the pyrometry unit is located at a side of the loading module.

4. The thin film processing apparatus as claimed in claim 1, wherein the heating unit has a plurality of radiant tungsten halogen lamps.

5. The thin film processing apparatus as claimed in claim 1, wherein the substrate and the auxiliary plate are made of glass with the same size, thermal properties and the high transmittance for thermal radiation.

6. (canceled)

7. The thin film processing apparatus as claimed in claim 1, wherein the pyrometer measures a thin film temperature via the substrate or the auxiliary plate.

8. The thin film processing apparatus as claimed in claim 1, wherein the substrate or the auxiliary plate allows a thermal radiation of heating unit to pass.

9. The thin film processing apparatus as claimed in claim 1, wherein the heating unit and the pyrometry unit are located on either side or the same side of the thin film.

10. The thin film processing apparatus as claimed in claim 1, wherein a temperature data measured by the pyrometry unit are transferred to the temperature control unit for adjusting an input power of each tungsten halogen lamp in accordance with a temperature requirement of the thin film.

11. (canceled)

12. (canceled)

13. (canceled)

14. The thin film processing apparatus as claimed in claim 1, wherein thin film processing apparatus is for the thin film is of solar cell.
